(19) United States
(12) Patent Application Publication
(10) Pub. No.: US 2016/0257026 A1
(43) Pub. Date: Sep. 8, 2016

(54) Hand-guided Power Tool with a Guide Bar

(71) Applicant: Andreas Stihl AG & Co. KG, Waiblingen (DE)

(72) Inventors: Thomas Lux, Welzheim (DE); Martin Rieber, Stuttgart (DE)

(21) Appl. No.: 15/060,945

(22) Filed: Mar. 4, 2016

(30) Foreign Application Priority Data
Mar. 4, 2015 (DE) 10 2015 002 719.0

(51) Int. Cl. B28D 1/08; B27B 17/12; B27B 17/02

(52) U.S. Cl. CPC B28D 1/082; B27B 17/02; B27B 17/12

(57) ABSTRACT

A power tool has a guide bar with clamping area to secure the guide bar to a power tool housing and with guide groove guiding a chain. The guide bar has side elements delimiting a main fluid channel and an auxiliary fluid channel. The main fluid channel has a main fluid inlet at the first side element in the clamping area, a first main fluid outlet at the deflection area of the guide bar, and a second main fluid outlet that opens into the guide groove at a first longitudinal side of the guide bar. A fluid quantity flowing in operation through the main fluid channel is greater than a fluid quantity flowing through the auxiliary fluid channel. The auxiliary fluid channel has a first auxiliary fluid outlet at the deflection area and a second auxiliary fluid outlet that opens at a second longitudinal side into the guide groove.

### BACKGROUND OF THE INVENTION

The invention relates to a hand-guided power tool with a guide bar, wherein the guide bar comprises a guide groove in which a chain is guided, wherein the guide bar at one end comprises a deflection area for deflection of the chain and at the other end comprises a clamping area for fixation on a housing of the power tool. The guide bar comprises a first side element and a second side element that delimit together a main fluid channel at least partially, wherein the main fluid channel comprises a main fluid inlet arranged on the first side element in the clamping area and wherein the main fluid channel further comprises at least a main fluid outlet that opens in the deflection area and comprises at least a second main fluid outlet that opens at a first longitudinal side of the guide bar into the guide groove.

The invention further relates to a guide bar for a hand-guided power tool wherein the guide bar comprises a guide groove in which a chain is guided, wherein the guide bar at one end comprises a deflection area for deflection of the chain and at the other end comprises a clamping area for fixation on a housing of the power tool. The guide bar comprises a first side element and a second side element that delimit a main fluid channel at least partially, wherein the main fluid channel comprises a main fluid inlet arranged on the first side element in the clamping area and wherein the main fluid channel further comprises at least a main fluid outlet that opens in the deflection area and comprises at least a second main fluid outlet that opens at a first longitudinal side of the guide bar into the guide groove.

Particularly when cutting mineral or metallic materials with a hand-guided power tool comprising a chain, in particular a concrete cutter, the abrasive sludge that is produced during cutting causes increased wear on the joints of the chain which leads to elongation of the chain. In order to reduce wear, the power tools of the aforementioned kind are usually designed such that in operation water is used for flushing the area of the joints of the chain. For this purpose, a water channel is provided in the guide bar that guides water to the longitudinal side of the guide bar into the area of the guide groove and to the deflection area. From this point, the water flushes the joints of the chain.

US 2012/0176806 A1 discloses a guide bar comprising a main water channel for a concrete cutter. The guide bar is comprised of two side plates and an intermediate element that delimit the main water channel. The main water channel has water outlets in the area of the deflecting sprocket and at the guide groove.

It has been found that comparatively great quantities of water are required for an optimal flushing action of the saw chain.

### SUMMARY OF THE INVENTION

It is an object of the present invention to provide a hand-guided power tool of the aforementioned kind that exhibits minimal fluid consumption and minimal wear of the chain.

In accordance with the present invention, this is achieved in that the side elements delimit an auxiliary fluid channel at least partially, wherein the fluid quantity that is flowing through the main fluid channel in operation is greater than the fluid quantity flowing through the auxiliary fluid channel and in that the auxiliary fluid channel comprises at least a first auxiliary fluid outlet that is opening within the deflection area and at least a second auxiliary fluid outlet which is opening at a second longitudinal side of the guide bar into the guide groove.

Moreover, it is an object of the present invention to provide a guide bar for a hand-guided power tool of the aforementioned kind that enables minimal fluid consumption and minimal wear of the chain.

In accordance with the present invention this is achieved in that the side elements delimit an auxiliary fluid channel at least partially, in that the auxiliary fluid channel comprises at least a first auxiliary fluid outlet that is opening within the deflection area and at least a second auxiliary fluid outlet which is opening at a second longitudinal side of the guide bar into the guide groove.

For the power tool it is provided that the side elements delimit a main fluid channel and an auxiliary fluid channel at least partially, wherein the auxiliary fluid channel comprises at least a first auxiliary fluid outlet that is opening in the deflection area and at least a second auxiliary fluid outlet that is opening at the second longitudinal side of the guide bar into the guide groove. By using at least two channels, i.e., the main fluid channel and the auxiliary fluid channel, the fluid that is provided for flushing the chain, in particular water, can be introduced in a simple and targeted way to the desired location. An unnecessary escape of fluid at locations that are not significantly contributing to the flushing action of the chain can be prevented. In this context, the main fluid channel and the auxiliary fluid channel are advantageously designed and connected with a fluid supply such that in operation more fluid flows through the main fluid channel than through the auxiliary fluid channel. Accordingly, in a simple way different fluid quantities can be supplied to different areas of the guide bar.

The power tool may be a motor chainsaw and the chain a saw chain. The saw chain comprises cutting teeth for processing a workpiece by material removal, wherein the workpiece is advantageously made of wood. The fluid which is conveyed through the fluid channels to the saw chain is in particular oil.

The power tool is particularly advantageously a concrete cutter and the chain serves for cutting mineral and/or metallic materials. The chain comprises in this context cutting elements that remove material from the workpiece by a grinding action. The cutting elements are advantageously grinding elements that comprise diamond particles.

Advantageously, the auxiliary fluid channel is fluidically connected with the main fluid channel such that in operation a portion of the fluid flowing in the main fluid channel flows from the main fluid channel into the auxiliary fluid channel. Accordingly, the auxiliary fluid channel can be supplied by means of the main fluid channel with fluid without a separate supply being required for the auxiliary fluid channel.

Expediently, in operation more than half of the fluid volume stream that is entering the main fluid channel flows to the main fluid outlets and less than half of the fluid volume stream entering the main fluid channel flows via the auxiliary fluid channel to the auxiliary fluid outlets. Preferably, in operation more than 60%, in particular more than 70%, advantageously approximately 80%, of the fluid volume stream entering the main fluid channel flows to the main fluid outlets and less than 40%, in particular less than 30%, in particular approximately 20%, of the fluid volume stream entering the main fluid channel flows via the auxiliary fluid channel to the auxiliary fluid outlets. In this way, most of the fluid or water exits through the main fluid outlets so that the chain is flushed in a targeted way at the main fluid outlets. At the same time, the chain is flushed with the smaller portion of the fluid or water in the area of the auxiliary fluid outlets. In this area, the chain is less strongly stressed and/or less strongly soiled so that the smaller fluid quantity is sufficient.

Preferably, in a longitudinal section of the guide bar a separating stay is extending directly between the main fluid channel and the auxiliary fluid channel. The separating stay separates the main fluid channel and the auxiliary fluid channel from each other and enables excellent guiding of the fluid, in particular with little pressure loss, within the respective fluid channels. Accordingly, the fluid is guided in a simple and reliable way to all provided fluid outlets. The separating stay forms a barrier extending transversely to the plane of extension of the guide bar between main fluid channel and auxiliary fluid channel. Accordingly, the two channels in the longitudinal section can extend across the entire width of the guide bar between the side elements. In this context, the longitudinal section is a section of the guide bar which is extending in the longitudinal direction and is delimited by two planes that are perpendicular to the longitudinal direction.

Expediently, in this longitudinal section of the guide bar a section of the main fluid channel extends, relative to a center plane, substantially mirror-symmetrical to a section of the auxiliary fluid channel, wherein the center plane contains a longitudinal center axis of the guide bar and is extending perpendicular to the plane of extension of the guide bar. Due to the mirror-symmetrical design, a simple configuration results. The different fluid quantities which flow in operation through the main fluid channel and the auxiliary fluid channel, respectively, are caused by the indirect supply to the auxiliary fluid channel from the main fluid channel and by means of throttling of the connection of the channels. A differing geometry of the channels is not provided. When reversing or turning over the guide bar, the main fluid channel and the auxiliary fluid channel are switched. Since the main fluid channel is connected with the housing-associated water outlet and the auxiliary fluid channel is connected by means of a throttle locations with the main fluid channel, for any position of the guide bar the desired fluid quantities within the main fluid channel and the auxiliary fluid channel will result.

Expediently, the first side element is contacting at least in sections thereof the second side element; the two side elements delimit the main fluid channel and the auxiliary fluid channel. In this way, the manufacture of the guide bar with formation of the fluid channels is simple and, at the same time, the guide bar is mechanically stable. In particular, the side elements are completely in contact with each other. In this way, the guide bar can be formed by only two side elements. However, it can also be advantageous that between the side elements an intermediate element is arranged and that the main fluid channel and the auxiliary fluid channel each are delimited at least partially by the intermediate element. In this way, the manufacture of the guide bar is particularly simple. In particular, the side elements and the intermediate element each can be designed as plates. The fluid channels can be, for example, stamped out of the plates. In this context, it is particular advantageous to provide only in the intermediate element stamped-out portions for the fluid channels. In the side elements there is advantageously only a stamped-out portion for connecting the fluid channel with the housing-associated water connector. The side elements and the intermediate element are, for example, connected by spot welding with each other.

Preferably, the intermediate element comprises at least a first penetration whose longitudinal sides delimit the main fluid channel and at least a second penetration was longitudinal sides delimit the auxiliary fluid channel. Penetrations in the intermediate element can be produced easily, for example, by stamping. A penetration can be produced with almost any contour so that the fluid channels can be optimally shaped in regard to fluid mechanics.

Expediently, the main fluid inlet and the second main fluid outlet are arranged on different sides relative to a center plane of the guide bar wherein the center plane contains a longitudinal center axis of the guide bar and is extending perpendicular to the plane of extension of the guide bar. Expediently, the main fluid inlet is arranged above the center plane the power tool is in its usual rest position. Accordingly, the guide bar can be clamped on the housing in a constructively simple way and, at the same time, the main fluid inlet can be supplied in a constructively simple way with fluid or water.

Advantageously, the chain is arranged so as to be circulating about the guide bar wherein in operation a first race or strand of the chain is running toward the deflection area and a second race or strand of the chain is running away from the deflection area and wherein the second main fluid outlet is arranged on the same side relative to the center plane as the second race/strand of the chain. The second race or strand of the chain usually performs the cut. The main portion of the fluid is therefore exiting below the center plane and is thus supplied to that part of the chain that must be flushed particularly well. By means of the main fluid outlet which is opening at the deflection area, a sufficient flushing at the deflection area is ensured at the same time.

Preferably, the auxiliary fluid channel comprises an auxiliary fluid inlet arranged within the clamping area and the auxiliary fluid inlet and the main fluid inlet are positioned at different sides relative to the center plane. The auxiliary fluid inlet in this context is advantageously not connected in operation with a water supply so that no fluid is supplied to the auxiliary fluid inlet. The auxiliary fluid channel is advantageously exclusively supplied by means of the main fluid channel with fluid. Expediently, the second auxiliary fluid outlet and the second main fluid outlet are arranged on different sides relative to the center plane. In particular, the inlets and outlets are symmetrically arranged relative to the center plane.

Expediently, the main fluid channel and the auxiliary fluid channel cross each other at a first crossing location wherein at the first crossing location the main fluid channel extends so as to be separated from the auxiliary fluid channel. Expediently, the main fluid channel and the auxiliary fluid channel cross each other at a second crossing location wherein at the second crossing location the main fluid channel extends so as to be separated from the auxiliary fluid channel. In this way, the inlets and outlets of the fluid channels can be arranged at different sides relative to the center plane, respectively, so that the guide bar can be filled optimally with fluid or water and the chain is supplied optimally with fluid or water at the same time.

Advantageously, the guide bar is designed to be reversible. Accordingly, the guide bar can be mounted easily because the operator must not pay attention to the position of the guide bar when installing it.

In connection with a guide bar for a hand-guided power tool it is provided that the side elements delimit at least partially an auxiliary fluid channel wherein the auxiliary fluid channel comprises at least a first auxiliary fluid outlet which opens in the deflection area and at least a second auxiliary fluid outlet which opens at a second longitudinal side of the guide bar into the guide groove. By using at least two channels, i.e., the main fluid channel and the auxiliary fluid channel, the fluid which is provided for flushing the chain, in particular water, can be guided in a simple and targeted way to the desired location on the chain. An unnecessary exit flow of water at locations that are not contributing significantly to the flushing action of the chain can be prevented substantially.

### BRIEF DESCRIPTION OF THE DRAWING

FIG. 1 is a perspective illustration of a concrete cutter.

FIG. 2 is a side view of a guide bar.

FIG. 3 is a perspective illustration of the guide bar.

FIG. 4 is a schematic illustration of the guide bar with main fluid channel and auxiliary fluid channel.

FIG. 5 is a schematic perspective illustration of the guide bar with main fluid channel and auxiliary fluid channel.

FIG. 6 is a section view along the section line VI-VI of FIG. 4.

FIG. 7 is a section view along the section line VII-VII of FIG. 4.

FIG. 8 is a view of the guide bar in the direction of arrow VIII in FIG. 4.

FIG. 9 is a side view of a guide bar of a further embodiment wherein a side element is removed.

FIG. 10 is a view in the direction of arrow X in FIG. 9.

FIG. 11 is a section view along the section line XI-XI of FIG. 9.

FIG. 12 is a section view along the section line XII-XII of FIG. 9.

FIG. 13 is a perspective illustration of a further embodiment showing the side element and the intermediate element which is arranged on the side element.

FIG. 14 is a side view of a guide bar in a further embodiment.

FIG. 15 is a perspective illustration of the guide bar of the embodiment according to FIG. 14.

FIG. 16 is a schematic illustration of an embodiment of a guide bar illustrating a flow path of the main fluid flow within the guide bar.

FIG. 17 is a schematic illustration of another embodiment of a guide bar illustrating the flow path of the main fluid flow in the guide bar.

FIG. 18 is a side view of a section of the chain of the concrete cutter.

### DESCRIPTION OF THE PREFERRED EMBODIMENTS

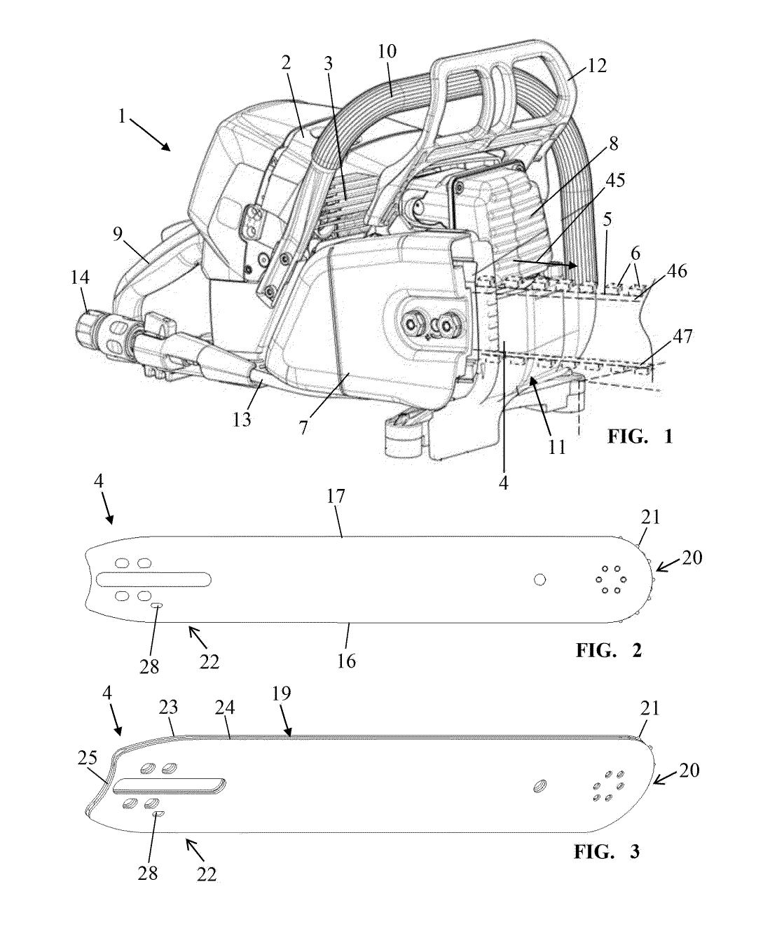

FIG. 1 shows a concrete cutter 1 as an embodiment of the hand-guided power tool; such a concrete cutter is of a similar design as a motor chain saw. The concrete cutter 1 comprises a housing 2 in which a drive motor 3 is arranged. The drive motor 3 is embodied as an internal combustion engine. In particular, it is a mixture-lubricated internal combustion engine and comprises an exhaust gas muffler 8 by means of which exhaust gases are escaping into the environment. The drive motor 3 can also be an electric motor which is, for example, supplied with energy by means of a power cable or a battery, in particular a rechargeable battery pack. On the housing 2, a guide bar 4 is secured which is schematically illustrated in FIG. 1. A chain 5 driven by the drive motor 3 is arranged so as to circulate about the guide bar 4. The chain 5 comprises a plurality of cutting elements 6. The cutting elements 6 are designed for cutting metal or mineral materials such as rock, concrete or the like. The hand-guided power tool can also be a motor chain saw having arranged on its guide bar a saw chain with cutting teeth. The chain 5 is driven by a drive pinion in running direction 45. The drive pinion is covered by sprocket cover 7 which is secured on the housing 2. The chain 5 comprises a first race or strand 46 which in operation moves from the drive pinion toward a deflection area 20 of the guide bar 4 (FIG. 2) and a second race or strand 47 which moves from the deflection area 20 toward the drive pinion.

On the housing 2, rear grip 9 as well as a handle 10 are secured. The rear grip 9 is arranged on the housing side which is facing away from the exhaust gas muffler 8 and the housing front side 11. The handle 10 spans the housing 2 at a spacing. In the area between the handle 10 and the guide bar 4 a hand guard 12 is arranged which is fixedly connected to the housing 2.

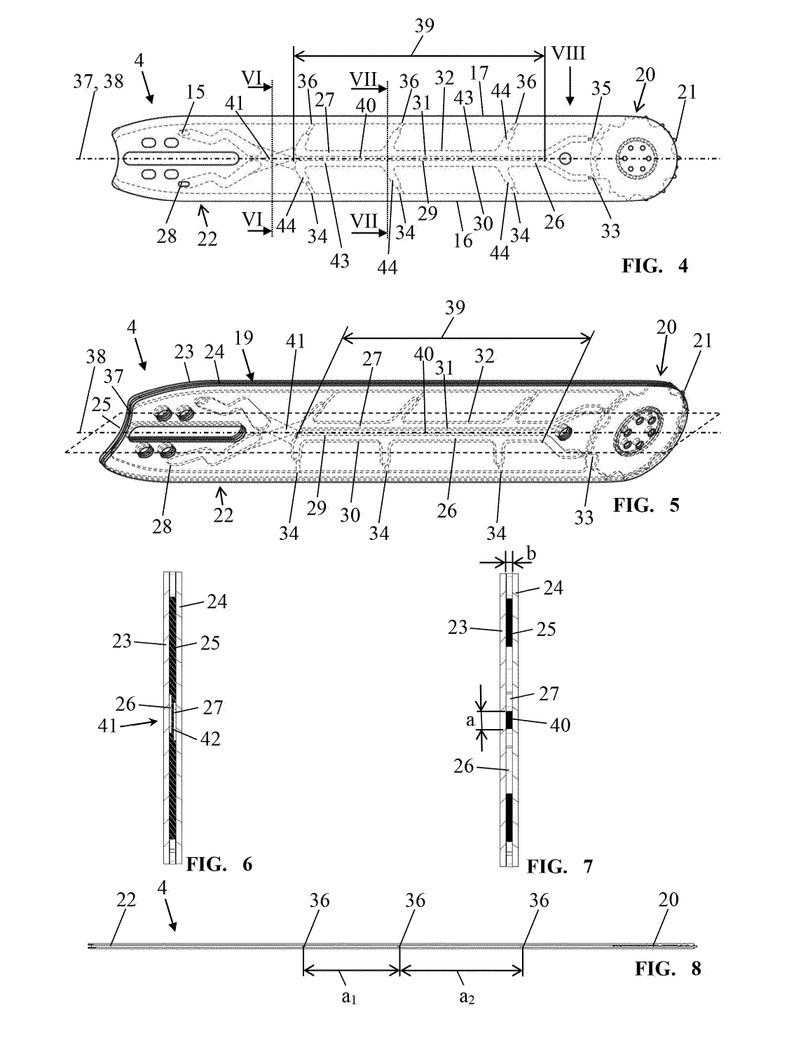

In operation, the chain 5 is flushed with a fluid, in the embodiment with water. For this purpose, a water conduit 13 is provided which is to be connected by a water connector 14 with a device for water supply. The water connector 14 is arranged at the rearward area of the rear grip 9. The water conduit 13 extends to a water outlet which is not visible in the Figures. The water outlet is arranged at the housing 2 underneath the sprocket cover 7 and is covered by the sprocket cover 7 and by the guide bar 4. A main fluid inlet 15 of the guide bar 4, illustrated in FIG. 4, is resting on the water outlet. By means of the main fluid inlet 15 the water exiting from the water outlet enters the guide bar 4. As will be explained in more detail infra, the water is guided in the channels within the guide bar 4 and exits at the longitudinal sides 16, 17 and at the deflection area 20 of the guide bar 4. Upon exiting, the water flushes the chain 5. At the same time, the water also binds the dust which is produced upon cutting and transports the removed material away. Also, the water cools the chain 5. Also, the water can be provided with additives, so that the water, for example, lubricates the chain 5. Instead of water, oil can be provided also as a fluid. The use of oil is suitable in particular when the hand-guided power tool is embodied as a motor chain saw and the chain 5 is a saw chain.

FIGS. 2 and 3 show the guide bar 4 in demounted state. The guide bar 4 comprises a guide groove 19 in which the chain 5 (FIG. 1) is guided. The deflection sprocket 21 is rotatably supported in the deflection area 20. The chain 5 is deflected in the deflection area 20 in operation, the chain 5 being guided by the deflection sprocket 21. At the other end of the guide bar 4, the guide bar 4 comprises a clamping area 22. The clamping area 22 is provided for fixation of the guide bar 4 on the housing 2 (FIG. 1). In the clamping area 22 the main fluid inlet 15 (FIG. 4) is arranged.

The guide bar 4 comprises a first side element 23 and a second side element 24. An intermediate element 25 is arranged between the side elements 23, 24. As shown in FIGS. 4 to 7, the side elements 23, 24 and the intermediate element 25 delimit a main fluid channel 26 and an auxiliary fluid channel 27. For this purpose, the intermediate element 25 comprises a first penetration which delimits with its sidewalls 29, 30 illustrated in FIGS. 4 and 5 the main fluid channel 26 over sections thereof. The intermediate element 25 comprises a second penetration whose sidewalls 31, 32 delimit the auxiliary fluid channel 27 over sections thereof.

The main fluid inlet 15 is arranged to the rear relative to the plane of illustration of FIG. 4. The main fluid inlet 15 is formed as an opening, for example, designed as a bore, cutout or the like, within the first side element 23. By means of the main fluid inlet 15, water is introduced into the main fluid channel 26 in operation. The main fluid channel 26 comprises a first main fluid outlet 33 which opens in the deflection area 20. The main fluid channel 26 comprises a second main fluid outlet 34 that is opening at the first longitudinal side 16 of the guide bar 4 into the guide grooves 19. In the embodiment, three second main fluid outlets 34 are provided which, in the running direction of the chain 5 (FIG. 1), have a spacing relative to each other. Preferably, the fluid outlets 34 are distributed uniformly across almost the entire length of the guide bar 4. Water exits in operation from the main fluid outlets 33, 34 and is supplied continuously to the chain 5 (FIG. 1).

In the embodiment, the main fluid channel 26 and the auxiliary fluid channel 27 are embodied to be approximately symmetrical, in particular approximately mirror-symmetrical, relative to a center plane 37. The center plane 37 contains a longitudinal center axis 38 of the guide bar 4 and is perpendicular to the plane of extension (defined by height and length) of the guide bar 4. In FIG. 4, in the front relative to the plane of illustration, an auxiliary fluid inlet 28 is arranged in the clamping area 22 and opens into the auxiliary fluid channel 27. The auxiliary fluid inlet 28 is designed as a bore, cutout or the like in the second side element 24. In usual operation, water is not supplied into the auxiliary fluid channel 27 by means of the auxiliary fluid inlet 28. The auxiliary fluid inlet 28 is required for reversing (turning over) the guide bar 4 because, after turning over the guide bar 4, the auxiliary fluid inlet 28 is positioned at the housing-associated water outlet and by means of the auxiliary fluid inlet 28 water is supplied into the auxiliary fluid channel 27 while in this case no water is supplied to the main fluid inlet 15. The housing-associated water outlet is in this context the water outlet which is formed on the housing 2 of the concrete cutter 1 from which the water passes from the housing 2 into the guide bar 4. The auxiliary fluid channel 27 comprises at least a first auxiliary fluid outlet 35 which opens in the deflection area 20. The auxiliary fluid channel 27 comprises at least a second auxiliary fluid outlet 36 opening at the second longitudinal side 17 of the guide bar 4 into the guide groove 19. In the embodiment, three second auxiliary fluid outlets 36 are provided which are spaced relative to each other in the running direction of the chain 5 (FIG. 1). In particular adjacent to the auxiliary fluid inlet 28, a further auxiliary fluid outlet, not illustrated in the Figures, can be arranged.

The main fluid channel 26 extends downstream of the main fluid inlet 15 first in a curved shape, in particular approximately in an S-shape, wherein the fluid in this section of the main fluid channel 26 changes several times its main flow direction, in the embodiment at least twice. The curved extension of the main fluid channel 26 extends approximately from the main fluid inlet 15 to the location where the main fluid channel 26 intersects the center plane 37. In a longitudinal section 39 of the guide bar 4 the main fluid channel 26 comprises a conveying channel 43 and several branch channels 44. The conveying channel 43 extends approximately parallel to the center plane 37. In order for the second main fluid outlets 34 to be supplied with fluid, the branch channels 44 are branching off the conveying channel 43. The branch channels 44 end at the main fluid outlets 34. The branch channels 44 extend at a slant relative to the longitudinal center axis 38 in the direction toward the deflection area 20 so that a channel extension having approximately a herringbone pattern results. The flow cross-section of each branch channel 44 tapers in the flow direction. Downstream of the longitudinal section 39 the spacing between the main fluid channel 26 and the center plane 37 increases and remains subsequently approximately constant. Farther downstream, the flow cross-section of the main fluid channel 26 tapers. Finally, the main fluid channel 26 opens into the first main fluid outlet 33.

The auxiliary fluid channel 27 is substantially symmetrical to the main fluid channel 26 so that the explanations provided supra in regard to the main fluid channel 26 apply likewise to the auxiliary fluid channel 27. The auxiliary fluid channel 27 also has a conveying channel 43 and branch channels 44.

In the longitudinal section 39 of the guide bar 4, a separating stay 40 is extending between the main fluid channel 26 and the auxiliary fluid channel 27. The separating stay 40 is formed within the intermediate element 25. Both side elements 23, 24 are contacting at least partially the separating stay 40. In the longitudinal section 39 the conveying channel 43 of the main fluid channel 26 and the conveying channel 43 of the auxiliary fluid channel 27 extend parallel to each other. The height a of the separating stay 40 which is illustrated in FIG. 7 is constant within the longitudinal section 39. As also shown in FIG. 7, the separating stay 40 has a width b which corresponds to the width of the intermediate element 25.

The main fluid channel 26 is fluidically connected with the auxiliary fluid channel 27 in such a way that in operation a portion of the fluid which is flowing within the main fluid channel 26 flows from the main fluid channel 26 into the auxiliary fluid channel 27. Water transfer takes place in particular in the area upstream of the separating stay 40, i.e., upstream of the longitudinal section 39. However, water can flow across also in the area of the separating stay 40 and in the area downstream of the separating stay 40. In order for the water to flow across, it is provided constructively in the embodiment that the side elements 23, 24 and the intermediate element 25 are not contacting each other seal-tightly. Constructively, this is realized, for example, by spot welding of the elements 23, 24, 25 wherein the fluidic communication is formed as a result of the leaks between the side elements 23, 24 which are not seal-tightly connected with the intermediate element 25. The leaks are provided in the embodiment at the locations where the main fluid channel 26 and the auxiliary fluid channel 27 are extended up to the same side element 23, 24. In operation, water is supplied only to the main fluid channel 26 by means of the main fluid inlet 15. The auxiliary fluid channel 27 is not connected with a housing-associated water supply. By means of the fluidic connection of the two channels 26, 27, water can pass from the main fluid channel 26 into the auxiliary fluid channel 27 and from there can exit via the auxiliary fluid outlets 35, 36. In the embodiment, in operation more than half of the fluid volume stream entering the main fluid channel 26 flows to the main fluid outlets 33, 34 and less than half of the fluid volume stream entering the main fluid channel 26 flows through the auxiliary fluid channel 27 to the auxiliary fluid outlets 35, 36. Preferably, in operation more than 60%, in particular more than 70%, advantageously approximately 80%, of the fluid volume stream entering the main fluid channel flows to the main fluid outlets and less than 40%, in particular less than 30%, in particular approximately 20%, of the fluid volume stream entering the main fluid channel flows through the auxiliary fluid channel to the auxiliary fluid outlets.

As a result of the fluid channels 26, 27 being substantially symmetrically embodied relative to the center plane 37, the auxiliary fluid outlets 35, 36 and the main fluid outlets 33, 34 are arranged on different sides relative to the center plane 37 and the main fluid inlet 15 and the auxiliary fluid inlet 28 are arranged on different sides relative to the center plane 37. As a result of the arrangement of the inlets 15, 28 and the outlets 33, 34, 35, 36 on different sides relative to the center plane 37, the main fluid channel 26 and the auxiliary fluid channel 27 are crossing each other at a first crossing location 41. In the embodiment, the first crossing location 41 is provided in an area between the clamping area 22 and the longitudinal section 39. At the first crossing location 41, the channels 26, 27 are extending separate from each other as can be seen in particular in FIG. 6.

In the embodiment according to FIGS. 4 and 5, the main fluid inlet 15 and the main fluid outlets 33, 34 are arranged on different sides relative to the center plane 37 of the guide bar 4. In operation, a first race (strand) 46 of the chain 5 (FIG. 1) is running toward the deflection area 21 and a second race (strand) 47 of the chain 5 (FIG. 1) extends away from the deflection area 21. The main fluid outlets 33, 34 are arranged on the same side relative to the center plane 37 as the second race 47 of the chain 5 (FIG. 1). Due to the arrangement of the main fluid outlets 33, 34 and because most of the water exits from the main fluid outlets 33, 34, the greater portion of the total water quantity introduced into the guide bar 4 is supplied to the returning portion of the chain 5 (FIG. 1) that is here the part of the chain 5 (FIG. 1) which is cutting the material in conventional working position of the concrete cutter 1 (FIG. 1). Accordingly, the chain 5 (FIG. 1) is flushed at the location where the abrasive sludge is formed as a result of the cutting process.

As shown in FIG. 6 and FIG. 7, the channel cross-section of the fluid channels 26, 27 changes at various locations of the fluid channels 26, 27. The channel cross-section of each one of the fluid channels 26, 27 is smaller at the first crossing location 41 (FIG. 6) than the channel cross-section of the corresponding fluid channels 26, 27 at a location downstream of the first crossing location 41 (FIG. 7). At the first crossing location 41, a separating wall 42 formed on the intermediate element 25 is provided between the fluid channels 26, 27. Accordingly, at the first crossing location 41 the main fluid channel 26 is delimited by the first side element 23 and the intermediate element 25 and at the first crossing location 41 the auxiliary fluid channel 26 is delimited by the second side element 24 and by the intermediate element 25. FIG. 7 shows that downstream of the first crossing location 41 the fluid channels 26, 27 each are delimited by the first side element 23, by the second side element 24, and by the intermediate element 25. Upstream of the first crossing location 41, the fluid channels 26, 27 are designed correspondingly.

FIG. 8 shows the arrangement of the second auxiliary fluid outlets 36 at the guide bar 4. The spacings a₁, a₂ of two respective neighboring second auxiliary fluid outlets 36 are different in the embodiment. The spacing a₁ of the two second auxiliary fluid outlets 36 that are positioned father toward the rear, i.e., closer to the clamping area 22, is smaller than the spacing a₂ of the two second auxiliary fluid outlets 36 that are located farther toward the front, i.e., closer to the deflection area 21. The same holds true also for the second main fluid outlets 34 because of the symmetrical arrangement.

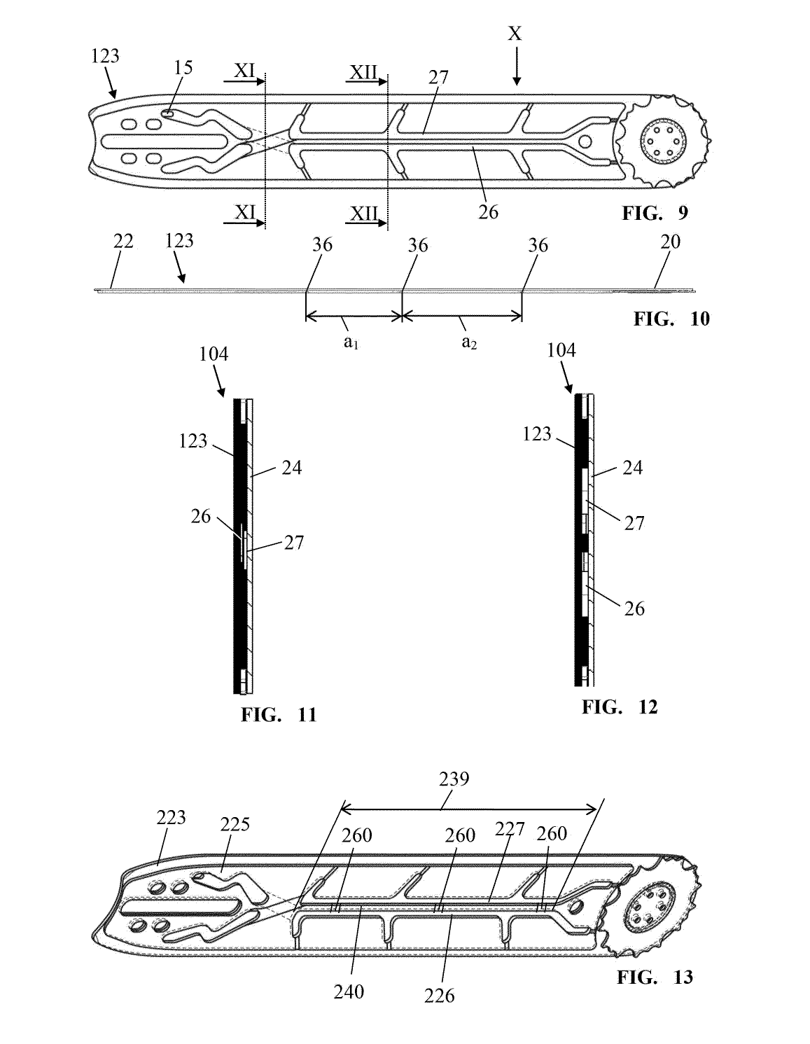

FIGS. 9 through 12 show a further embodiment of a side element 123 for a guidebar 104 (FIGS. 11 and 12). The guide bar 104 comprises, as shown in FIGS. 11 and 12, the side element 123 as well as the side element 24. In this context, same reference characters indicate in all Figures elements that correspond to each other. The side element 123 illustrated in FIGS. 9 to 12 corresponds substantially to the first side element 23 shown in FIGS. 2 to 8. On the side element 123 according to FIGS. 9 to 12 the intermediate element is integrally formed. An intermediate element 25 as a separate component of the guide bar can thus be dispensed with in this embodiment. The side element 123 is at least partially contacting the second side element 24. The side elements 123 and 124 delimit the main fluid channel 26 and the auxiliary fluid channel 27 (FIG. 9).

FIG. 13 shows a further embodiment of an intermediate element 225 which substantially corresponds to the intermediate element 25 illustrated in FIGS. 2 to 8. The fluid channels 226 and 227 are formed on the intermediate element 225. A significant difference to the intermediate element 25 resides in that at least a connecting channel 260 is formed in the area of a longitudinal section 239 on a separating stay 240 that is arranged between the fluid channels 226, 227. The connecting channel 260 connects the two fluid channels 226, 227 fluidically with each other so that in operation a flow of fluid from the main fluid channel 226 into the auxiliary fluid channel 227 is realized by means of the connecting channel 260. In the embodiment, a total of three connecting channels 260 are provided. Instead of the connecting channel 260, at least one throttle element, not illustrated, can also be provided which guides a portion of the fluid flow which is flowing within the main fluid channel 226 into the auxiliary fluid channel 225. The throttle element in this context is effective in both attachment positions of the guide bar 4. Accordingly, despite geometrically identical configuration of the main fluid channel 26 and the auxiliary fluid channel 27, a reduced fluid transfer of the auxiliary fluid channel 27 is achieved. In a further embodiment, not illustrated, the cross-sections of the auxiliary fluid outlets 35, 36 can be smaller than the cross-sections of the main fluid outlets 33, 34. In this embodiment, reversal (turning over) of the guide bar 4 is not possible.

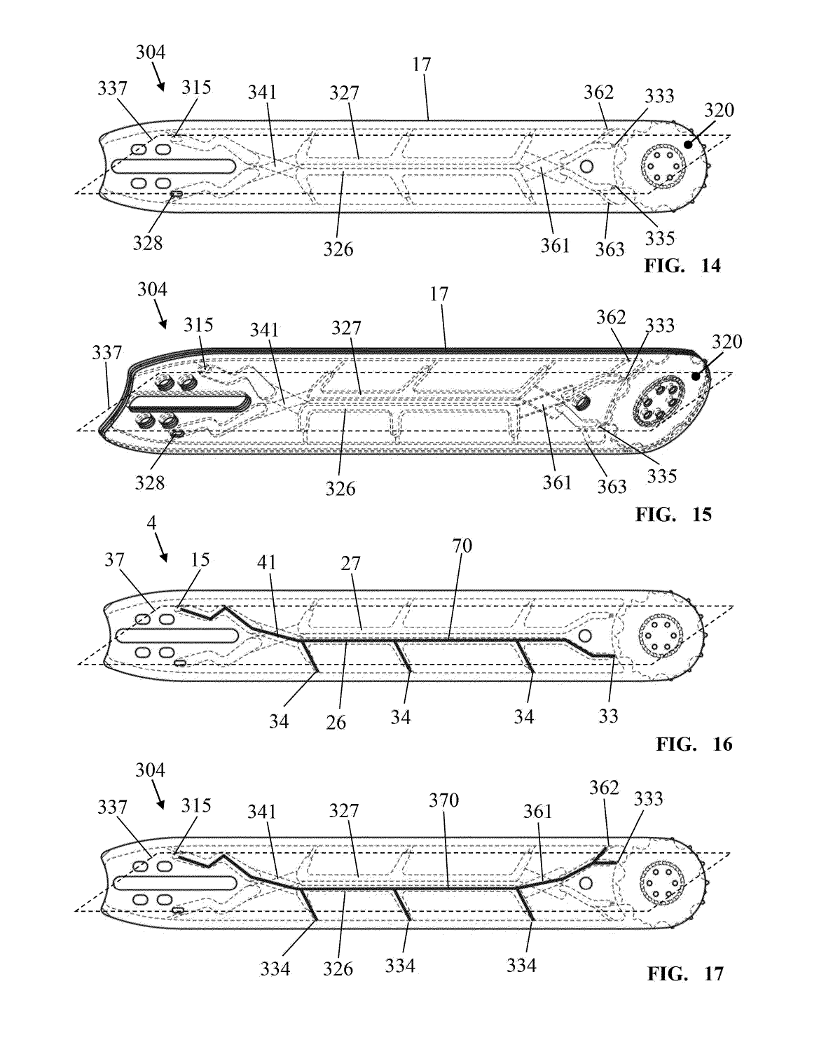

FIGS. 14 and 15 show a further embodiment of a guide bar 304 which mostly corresponds to the guide bar 4 illustrated in FIGS. 2 to 8. The significant difference of the guide bar 304 illustrated in FIGS. 14 and 15 relative to the guide bar 4 illustrated in FIGS. 2 to 8 is that a main fluid channel 326 and an auxiliary fluid channel 327 cross each other at a first crossing location 341 and at a second crossing location 361 in the guide bar 304 shown in FIGS. 14 and 15. At the second crossing location 361, the main fluid channel 326 is extending so as to be separated from the auxiliary fluid channel 327. The main fluid channel 326 comprises a first main fluid outlet 333 opening at the deflection area 320 which is arranged downstream of the second crossing location 361. The main fluid outlet 333 is arranged on the same side relative to the center plane 337 as the main fluid inlet 315. Water that is exiting through the main fluid outlet 333 is supplied to the chain 5 (FIG. 1) in the running direction 45 (FIG. 1) before the chain passes the deflection area 320. In addition, downstream of the second crossing location 361, the main fluid channel 326 comprises a third main fluid outlet 362 opening at the second longitudinal side 17 (FIG. 3) of the guide bar 304 into the guide groove 19 (FIG. 3). The third main fluid outlet 362 is positioned on the same side relative to the center plane 337 as the main fluid inlet 315. As a result of the symmetrical arrangement, the explanations provided above in regard to the main fluid channel 326 apply likewise to the auxiliary fluid channel 327. In particular, a first auxiliary fluid outlet 335, a third auxiliary fluid outlet 363, and an auxiliary fluid inlet 328 are on the same side relative to the center plane 337.

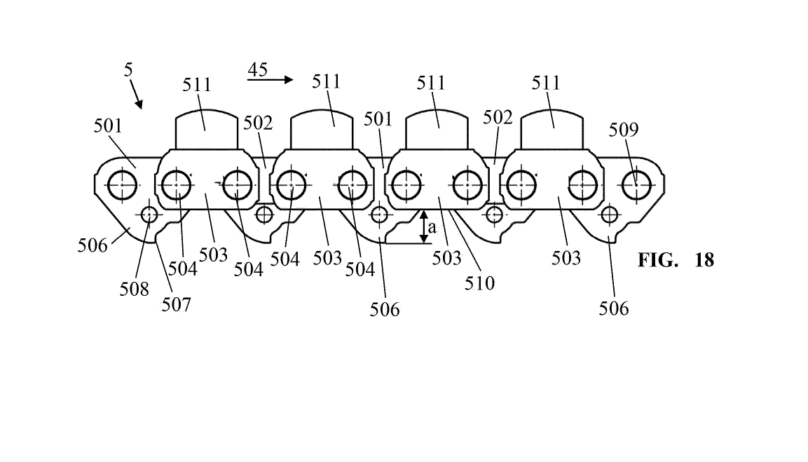

FIGS. 16 and 17 are meant to show schematically the flow of the water 70, 370 in the main fluid channel 26, 326 of the guide bar 4, 304 in operation of the concrete cutter 1 (FIG. 1). To simplify the illustration, in FIGS. 16 and 17 the transfer of water 70, 370 from the main fluid channel 26, 326 into the auxiliary fluid channel 27, 327 and the flow of water 70, 370 in the auxiliary fluid channel 27, 327 is not illustrated.

FIG. 16 shows the guide bar 4 in the embodiment according to FIGS. 2 to 8 in which the main fluid channel 26 and the auxiliary fluid channel 27 are crossing at the first crossing location 41. The water 70 passes through the main fluid inlet 15 into the main fluid channel 26. Up to the first crossing location 41 the water 70 flows above the center plane 37 and, beginning approximately at the first crossing location 41, the water 70 then flows below the center plane 37. The water 70 exits via the first main fluid outlet 33 and the second main fluid outlet 34 below the center plane 37 from the main fluid channel 26.

FIG. 17 shows the guidebar 304 in the embodiment according to FIGS. 14 and 15 in which the main fluid channel 326 and the auxiliary fluid channel 327 cross each other at the first crossing location 341 and at the second crossing location 361, respectively. The water 370 passes through the main fluid inlet 315 into the main fluid channel 326. Up to approximately the first crossing location 341, the water 370 flows above the center plane 337; approximately downstream of the first crossing location 341, the water 370 flows below the center plane 337 approximately to the second crossing location 361; and approximately beginning at the second crossing location 361 the water 370 flows then above the center plane 337. The water exits via the second main fluid outlet 334 below the center plane 337 from the main fluid channel 326. The water 370 exits via the first main fluid outlet 333 and the third main fluid outlet 362 above the center plane 337 from the main fluid channel 326.

FIG. 18 shows the configuration of the chain 5 in detail. Chain 5 is constructed of central connecting members 501, 502 which are connected to each other by lateral connecting members 503. All members of the chain 5 are connected to each other by connecting bolts 504 so as to be pivotable. In the running direction 45 of the chain 5, the first central connecting members 501 and the second central connecting members 502 alternate. The first central connecting members 501 are designed as driver members and comprise a driver projection 506 which projects into the guide groove 19 (FIG. 3) formed on the guide bar 4 (FIG. 1). By means of the driver projection 506 the first central connecting members 501 are driven by the drive pinion. At the leading side in the running direction 45, each driver projection 506 has a cutout 507 that is designed such that sludge and dirt collecting in the guide bar 4 (FIG. 1) are entrained by the drive projections 506. The driver projections 506 comprise also a bore 508 which serves for better distribution of the water 70, 370 (FIGS. 16 and 17).

The lateral connecting members 503 each support cutting segments 511. Each cutting segment 511 is fixedly connected with two connecting members 503 which in the running direction 45 are positioned laterally adjacent to each other so that the cutting segments 511 project away from the chain 5 across the entire chain width and also extend partially across the central connecting members 501 and 502.

In all embodiments, the same reference characters correspond to same components. In case of substantially identical components, in the embodiment according to FIG. 9 through 12 the number 100 has been added to the reference characters of the corresponding components in the embodiments of FIGS. 2 through 8. For substantially similar components, in the embodiments according to FIG. 13, the number 200 has been added to the reference characters of the corresponding components of the embodiment of FIGS. 2 to 8. For substantially identical components, in the embodiment according to FIGS. 14 to 17, the number 300 has been added to the reference characters of the corresponding components of the embodiment of FIGS. 2 to 8. The individual embodiments can also be suitably combined with each other. In all embodiments, openings between the fluid channels can be provided on the separating stay 40. In all embodiments, further crossing locations of the fluid channels can be provided.

The specification incorporates by reference the entire disclosure of German priority document 10 2015 002 719.0 having a filing date of Mar. 4. 2015.

While specific embodiments of the invention have been shown and described in detail to illustrate the inventive principles, it will be understood that the invention may be embodied otherwise without departing from such principles.

What is claimed is:

1. A hand-guided power tool comprising:
a housing;
a guide bar comprising a first end and a second end, wherein the first end comprises a deflection area and the second end comprises a clamping area configured to secure the guide bar to the housing;
a chain;
the guide bar comprising a guide groove in which the chain is guided, wherein the chain is deflected at the deflection area toward the second end;
the guide bar comprising a first side element and a second side element, wherein the first and second side elements delimit a main fluid channel at least partially;
the main fluid channel comprising a main fluid inlet arranged on the first side element in the clamping area;
the main fluid channel comprising at least a first main fluid outlet that opens in the deflection area;
the main fluid channel comprising at least a second main fluid outlet that opens into the guide groove at a first longitudinal side of the guide bar:
the first and second side elements delimiting an auxiliary fluid channel at least partially, wherein in operation of the power tool a fluid passes through the main fluid channel and the auxiliary fluid channel, wherein a fluid quantity of the fluid flowing through the main fluid channel is greater than a fluid quantity of the fluid flowing through the auxiliary fluid channel;
the auxiliary fluid channel comprising at least a first auxiliary fluid outlet that opens in the deflection area and at least a second auxiliary fluid outlet that opens into the guide groove at a second longitudinal side of the guide bar.

2. The power tool according to claim 1, wherein the auxiliary fluid channel is fluidically connected with the main fluid channel such that in operation of the power tool a portion of the fluid flowing within the main fluid channel flows from the main fluid channel into the auxiliary fluid channel.

3. The power tool according to claim 2, wherein in operation of the power tool more than half of a volume stream of the fluid entering the main fluid channel flows to the first and second main fluid outlets and wherein less than half of the volume stream of the fluid entering the main fluid channel flows through the auxiliary fluid channel to the first and second auxiliary fluid outlets.

4. The power tool according to claim 1, wherein the guide bar comprises a longitudinal section and wherein the longitudinal section comprises a separating stay extending directly between the main fluid channel and the auxiliary fluid channel.

5. The power tool according to claim 4, wherein the guide bar comprises a longitudinal center axis extending from the first end to the second end and further comprises a height perpendicular to the longitudinal center axis, wherein a plane of extension of the guide bar is defined by the height and the longitudinal center axis, wherein the guide bar comprises a center plane that extends perpendicular to the plane of extension and contains the longitudinal center axis, wherein, relative to the center plane, a section of the main fluid channel is extending mirror-symmetrical to a section of the auxiliary fluid channel in the longitudinal section of the guide bar.

6. The power tool according to claim 1, wherein the first side element contacts at least partially the second side element and wherein the first and second side elements delimit the main fluid channel and the auxiliary fluid channel.

7. The power tool according to claim 1, wherein between the first and second side elements an intermediate element is arranged and wherein the main fluid channel and the auxiliary fluid channel each are at least partially delimited by the intermediate element.

8. The power tool according to claim 7, wherein the intermediate element comprises at least a first penetration with first sidewalls that delimit the main fluid channel and wherein the intermediate element comprises at least a second penetration with second sidewalls that delimit the auxiliary fluid channel.

9. The power tool according to claim 1, wherein the guide bar comprises a longitudinal center axis extending from the first end to the second end and further comprises a height perpendicular to the longitudinal center axis, wherein a plane of extension of the guide bar is defined by the height and the longitudinal center axis, wherein the guide bar comprises a center plane that extends perpendicular to the plane of extension and contains the longitudinal center axis, wherein the main fluid inlet and the second main fluid outlet are arranged on different sides of the guide bar relative to the center plane of the guide bar.

10. The power tool according to claim 9, wherein the chain is arranged to circulate about the guide bar, wherein in operation of the power tool a first race of the chain runs from the clamping area toward the deflection area and a second race of the chain runs away from the deflection area toward the clamping area, wherein the second main fluid outlet is arranged on the same side of the guide bar relative to the center plane as the second race of the chain.

11. The power tool according to claim 9, wherein the auxiliary fluid channel comprises an auxiliary fluid inlet arranged in the clamping area and wherein the auxiliary fluid inlet and the main fluid inlet are arranged on different sides of the guide bar relative to the center plane.

12. The power tool according to claim 9, wherein the second auxiliary fluid outlet and the second main fluid outlet are arranged on different sides of the guide bar relative to the center plane.

13. The power tool according to claim 1, wherein the main fluid channel and the auxiliary fluid channel cross each other at a first crossing location, wherein the main fluid channel is separated from the auxiliary fluid channel at the first crossing location.

14. The power tool according to claim 13, wherein the main fluid channel and the auxiliary fluid channel cross each other at a second crossing location, wherein the main fluid channel is separated from the auxiliary fluid channel at the second crossing location.

15. The power tool according to claim 1, wherein the guide bar is embodied to be reversible.

16. A guide bar for a hand-guided power tool, the guide bar comprising:
a first end and a second end, wherein the first end comprises a deflection area and the second end comprises a clamping area configured to secure the guide bar to a housing of the power tool;
a guide groove in which a chain of the power tool is guided so as to be deflected at the deflection area toward the second end;
a first side element and a second side element, wherein the first and second side elements delimit a main fluid channel at least partially;
the main fluid channel comprising a main fluid inlet arranged on the first side element in the clamping area;
the main fluid channel comprising at least a first main fluid outlet that opens in the deflection area;
the main fluid channel comprising at least a second main fluid outlet that opens into the guide groove at a first longitudinal side of the guide bar;
the first and second side elements delimiting an auxiliary fluid channel at least partially;
the auxiliary fluid channel comprising at least a first auxiliary fluid outlet that opens in the deflection area and at least a second auxiliary fluid outlet that opens at a second longitudinal side of the guide bar into the guide groove.
